(19) United States
(12) Patent Application Publication
(10) Pub. No.: US 2017/0174549 A1
(43) Pub. Date: Jun. 22, 2017

(54) METHOD AND SYSTEM FOR SCORING GLASS SHEET

(71) Applicant: Corning Incorporated, Corning, NY (US)

(72) Inventors: Pamela Ann Hajcak, Watkins Glen, NY (US); Ritesh Satish Lakhkar, Painted Post, NY (US); Mark Thomas Massaro, Murray, KY (US); George Davis Treichler, Hammondsport, NY (US)

(21) Appl. No.: 15/301,517

(22) PCT Filed: Apr. 1, 2015
(86) PCT No.: PCT/US2015/023777

§ 371 Date: Oct. 3, 2016

Related U.S. Application Data
(60) Provisional application No. 61/975,243, filed on Apr. 4, 2014.

(51) Int. Cl. C03B 33/023; C03B 21/02; C03B 33/02

(52) U.S. Cl. CPC C03B 33/023; C03B 33/02; C03B 21/02

(57) ABSTRACT

A method includes scoring a glass sheet to form a scored region of the glass sheet. The scored region extends in a longitudinal direction and comprises a plurality of deep score portions and a shoulder portion disposed longitudinally between adjacent deep score portions. The glass sheet is severed along a severing line extending in a transverse direction substantially perpendicular to the longitudinal direction and through the shoulder portion of the scored region.

This application claims the benefit of priority to U.S. Application No. 61/975,243 filed on Apr. 4, 2014 the content of which is incorporated herein by reference in its entirety.

### BACKGROUND

### 1. Field

This disclosure relates to glass sheets, and more particularly to methods and apparatuses for scoring glass sheets.

### 2. Technical Background

A glass sheet can be formed using a variety of different processes. The glass sheet can be severed to separate a glass pane therefrom. The glass pane can be processed further (e.g., during a cutting or molding process) to form a glass article.

### SUMMARY

Disclosed herein are methods and systems for scoring a glass sheet.

Disclosed herein is a method comprising scoring a glass sheet to form a scored region of the glass sheet. The scored region extends in a longitudinal direction and comprises a plurality of deep score portions and a shoulder portion disposed longitudinally between adjacent deep score portions. The glass sheet is severed along a severing line extending in a transverse direction substantially perpendicular to the longitudinal direction and through the shoulder portion of the scored region.

Also disclosed herein is a method comprising forming a score in a glass sheet by contacting the glass sheet with a scoring member. A viscosity of a contacted region of the glass sheet in contact with the scoring member is at least about 1×10⁶ kP.

Also disclosed herein is a system comprising a scoring member and a severing unit disposed longitudinally downstream of the scoring member. The scoring member is engageable with a moving glass sheet at alternating high and low engaging forces to form a dashed score extending longitudinally along the glass sheet. The severing unit is engageable with the glass sheet along a severing line extending in a transverse direction substantially perpendicular to the longitudinal direction along the glass sheet. The scoring member and the severing unit are synchronized such that the severing line is disposed at a longitudinal region of the glass sheet previously engaged by the scoring member at the low engaging force.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic view of one exemplary embodiment of a system for scoring and severing a glass sheet.

FIG. 2 is a cross-sectional view of one exemplary embodiment of a glass sheet.

FIG. 3 is a cross-sectional view of one exemplary embodiment of forming unit that can be used to form a glass sheet.

FIG. 4 is a perspective view of one exemplary embodiment of a scoring unit forming a score in a glass sheet.

FIG. 5 is a side view of the scoring unit of FIG. 4.

FIG. 6 illustrates a glass sheet with one exemplary embodiment of a dashed score formed therein.

FIG. 7 is a cross-sectional view of a glass sheet with one exemplary embodiment of a dashed score formed therein, taken along the score.

FIG. 8 is a cross-sectional view of a glass sheet with another exemplary embodiment of a dashed score formed therein, taken along the score.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

As used herein, the term “average coefficient of thermal expansion” refers to the average coefficient of thermal expansion of a given material or layer between 0° C. and 300° C. As used herein, the term “coefficient of thermal expansion” refers to the average coefficient of thermal expansion unless otherwise indicated.

In various embodiments, a glass sheet comprises at least a first layer and a second layer. For example, the first layer comprises a core layer, and the second layer comprises one or more cladding layers adjacent to the core layer. The first layer and/or the second layer are glass layers comprising a glass, a glass-ceramic, or a combination thereof. In some embodiments, the first layer and/or the second layer are transparent glass layers.

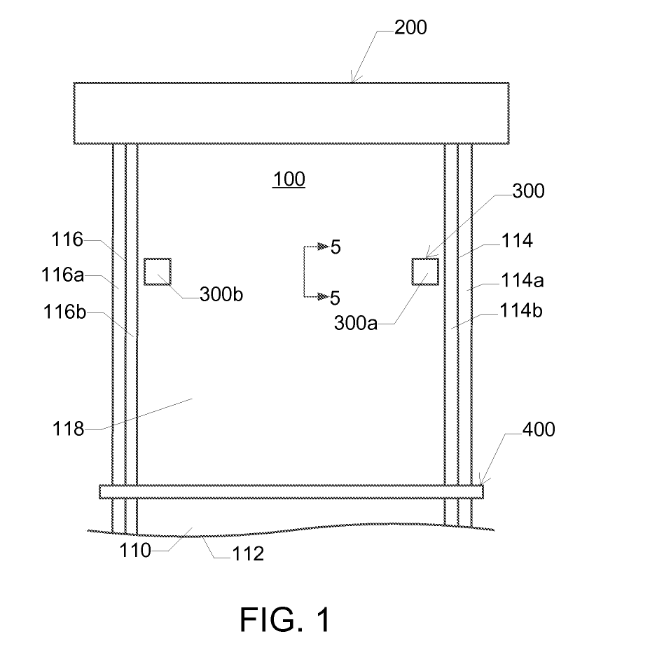

FIG. 1 is a schematic illustration of one exemplary system that can be used to score a glass sheet 100. In some embodiments, glass sheet 100 is formed using a forming unit 200, and the system scores the glass sheet as it travels away from the forming unit as shown in FIG. 1 and described herein. Thus, glass sheet 100 is integrally connected to a molten glass source during the scoring of the glass sheet. In other embodiments, the system scores the glass sheet as part of an off-line process (i.e., after the glass sheet has been formed and removed from the forming unit). The system comprises a scoring unit 300 for forming a score in glass sheet 100 as described herein. In some embodiments, the system can be used to sever the scored glass sheet. For example, the system comprises a severing unit 400 for severing glass sheet 100 and separating a glass pane from the glass sheet as described herein.

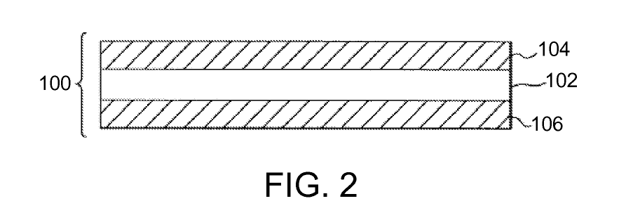

FIG. 2 is a cross-sectional view of one exemplary embodiment of glass sheet 100. In some embodiments, glass sheet 100 comprises a laminated sheet comprising a plurality of glass layers. Glass sheet 100 can be substantially planar as shown in FIG. 2 or non-planar. Glass sheet 100 comprises a core layer 102 disposed between a first cladding layer 104 and a second cladding layer 106. In some embodiments, first cladding layer 104 and second cladding layer 106 are exterior layers as shown in FIG. 2. In other embodiments, the first cladding layer and/or the second cladding layer are intermediate layers disposed between the core layer and an exterior layer.

Core layer 102 comprises a first major surface and a second major surface opposite the first major surface. In some embodiments, first cladding layer 104 is fused to the first major surface of core layer 102. Additionally, or alternatively, second cladding layer 106 is fused to the second major surface of core layer 102. In such embodiments, the interfaces between first cladding layer 104 and core layer 102 and/or between second cladding layer 106 and core layer 102 are free of any bonding material such as, for example, an adhesive, a coating layer, or any non-glass material added or configured to adhere the respective cladding layers to the core layer. Thus, first cladding layer 104 and/or second cladding layer 106 are fused directly to core layer 102 or are directly adjacent to core layer 102. In some embodiments, the glass sheet comprises one or more intermediate layers disposed between the core layer and the first cladding layer and/or between the core layer and the second cladding layer. For example, the intermediate layers comprise intermediate glass layers and/or diffusions layers formed at the interface of the core layer and the cladding layer. In some embodiments, glass sheet 100 comprises a glass-glass laminate (e.g., an in situ fused multilayer glass-glass laminate) in which the interfaces between directly adjacent glass layers are glass-glass interfaces.

In some embodiments, core layer 102 comprises a first glass composition, and first and/or second cladding layers 104 and 106 comprise a second glass composition that is different than the first glass composition. For example, in the embodiment shown in FIG. 2, core layer 102 comprises the first glass composition, and each of first cladding layer 104 and second cladding layer 106 comprises the second glass composition. In other embodiments, the first cladding layer comprises the second glass composition, and the second cladding layer comprises a third glass composition that is different than the first glass composition and/or the second glass composition.

As shown in FIG. 1, glass sheet 100 comprises a first surface 110 and a second surface 112 opposite the first surface. A first edge region 114 extends in a longitudinal direction along a length of glass sheet 100 adjacent to a first side edge of the glass sheet. A second edge region 116 extends in the longitudinal direction along the length of glass sheet 100 adjacent to a second side edge of the glass sheet opposite the first side edge. A central region 118 of glass sheet 100 is disposed between first edge region 114 and second edge region 116. In some embodiments, central region 118 is thinner than first edge region 114 and/or second edge region 116. For example, first edge region 114 and/or second edge region 116 comprise beads extending longitudinally along glass sheet 100. The beads can be relatively thick regions formed near the side edges of glass sheet 100. In some embodiments, the beads are thicker than central region 118 of glass sheet 100.

In some embodiments, core layer 102 is partially uncovered by first cladding layer 104 and/or second cladding layer 106 of glass sheet 100 as shown in FIG. 1. For example, core layer 102 is wider than first cladding layer 104 and/or second cladding layer 106 such that the core layer is at least partially uncovered at first edge region 114 and/or second edge region 116. In some of such embodiments, first edge region 114 comprises a plurality of beads. For example, a first bead 114a extends along an edge of core layer 102, and a second bead 114b extends along an edge of first cladding layer 104 and second cladding layer 106 as shown in FIG. 1. Thus, first bead 114a extends longitudinally along an outer edge of first edge region 114, and second bead 114b extends longitudinally along an inner edge of the first edge region. Additionally, or alternatively, second edge region 116 comprises a plurality of beads. For example, a first bead 116a extends along an edge of core layer 102, and a second bead 116b extends along an edge of first cladding layer 104 and second cladding layer 106 as shown in FIG. 1. Thus, first bead 116a extends longitudinally along an outer edge of second edge region 116, and second bead 116b extends longitudinally along an inner edge of the second edge region. In other embodiments, the glass sheet comprises a single bead extending longitudinally along the uncovered region of the core layer in the first edge region (e.g., longitudinally along the outer edge or the inner edge of the first edge region) and/or a single bead extending longitudinally along the uncovered region of the core layer in the second edge region (e.g., longitudinally along the outer edge or the inner edge of the second edge region).

In other embodiments, the first edge region and/or the second edge region can comprise a greater number of beads. For example, in some embodiments, the first cladding layer and the second cladding layer have different widths such that the first edge region and/or the second edge region comprise a bead extending along an edge of each of the core layer, the first cladding layer, and the second cladding layer. In other embodiments, the continuous ribbon comprises one or more intermediate layers having different widths than the core layer, the first cladding layer, and the second cladding layer such that the first edge region and/or the second edge region comprises a bead extending along edges of the intermediate layers.

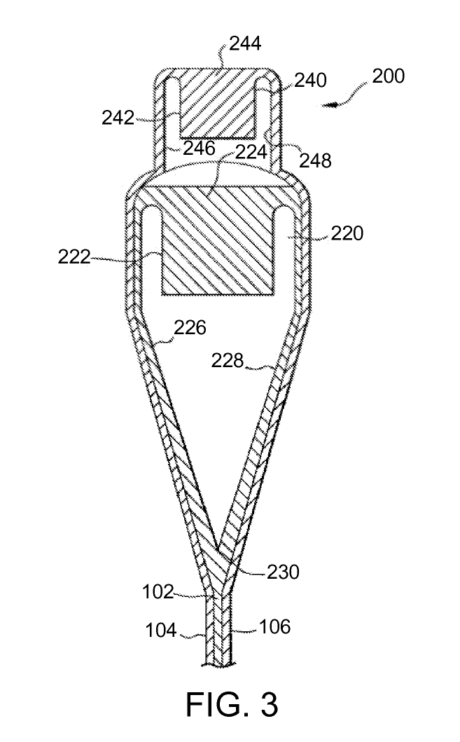

The glass sheet can be formed using a suitable process such as, for example, a fusion draw, down draw, slot draw, up draw, or float process. In some embodiments, the glass sheet is formed using a fusion draw process. FIG. 3 is a cross-sectional view of one exemplary embodiment of forming unit 200 configured as an overflow distributor that can be used to form a glass sheet such as, for example, glass sheet 100. Forming unit 200 can be configured as described in U.S. Pat. No. 4,214,886, which is incorporated herein by reference in its entirety. For example, forming unit 200 comprises a lower overflow distributor 220 and an upper overflow distributor 240 positioned above the lower overflow distributor. Lower overflow distributor 220 comprises a trough 222. A first glass composition 224 is melted and fed into trough 222 in a viscous state. First glass composition 224 forms core layer 102 of glass sheet 100 as further described below. Upper overflow distributor 240 comprises a trough 242. A second glass composition 244 is melted and fed into trough 242 in a viscous state. Second glass composition 244 forms first and second cladding layers 104 and 106 of glass sheet 100 as further described below.

First glass composition 224 overflows trough 222 and flows down opposing outer forming surfaces 226 and 228 of lower overflow distributor 220. Outer forming surfaces 226 and 228 converge at a draw line 230. The separate streams of first glass composition 224 flowing down respective outer forming surfaces 226 and 228 of lower overflow distributor 220 converge at draw line 230 where they are fused together to form core layer 102 of glass sheet 100.

Second glass composition 244 overflows trough 242 and flows down opposing outer forming surfaces 246 and 248 of upper overflow distributor 240. Second glass composition 244 is deflected outward by upper overflow distributor 240 such that the second glass composition flows around lower overflow distributor 220 and contacts first glass composition 224 flowing over outer forming surfaces 226 and 228 of the lower overflow distributor. The separate streams of second glass composition 244 are fused to the respective separate streams of first glass composition 224 flowing down respective outer forming surfaces 226 and 228 of lower overflow distributor 220. Upon convergence of the streams of first glass composition 224 at draw line 230, second glass composition 244 forms first and second cladding layers 104 and 106 of glass sheet 100.

In some embodiments, first glass composition 224 of core layer 102 in the viscous state is contacted with second glass composition 244 of first and second cladding layers 104 and 106 in the viscous state to form the glass sheet. In some of such embodiments, the glass sheet comprises a glass ribbon traveling away from draw line 230 of lower overflow distributor 220 as shown in FIG. 3. The glass ribbon can be drawn away from lower overflow distributor 220 by a suitable means including, for example, gravity and/or pulling rollers. The glass ribbon cools as it travels away from lower overflow distributor 220. The glass ribbon can be scored and/or severed as described herein. For example, a laminated pane can be cut from the glass ribbon using a suitable technique such as, for example, scoring, bending, thermally shocking, and/or laser cutting. The laminated pane can be processed further (e.g., by cutting or molding) to form a glass article.

Although glass sheet 100 shown in FIG. 2 comprises three layers, other embodiments are included in this disclosure. In other embodiments, a glass sheet can have a determined number of layers, such as one, two, four, or more layers. For example, a glass sheet comprising one layer can be formed using a single overflow distributor (e.g., the lower overflow distributor 220 without the upper overflow distributor 240). A glass sheet comprising two layers can be formed using two overflow distributors positioned so that the two layers are joined while traveling away from the respective draw lines of the overflow distributors or using a single overflow distributor with a divided trough so that two glass compositions flow over opposing outer forming surfaces of the overflow distributor and converge at the draw line of the overflow distributor. A glass sheet comprising four or more layers can be formed using additional overflow distributors and/or using overflow distributors with divided troughs. Thus, a glass sheet having a determined number of layers can be formed by modifying the overflow distributor accordingly.

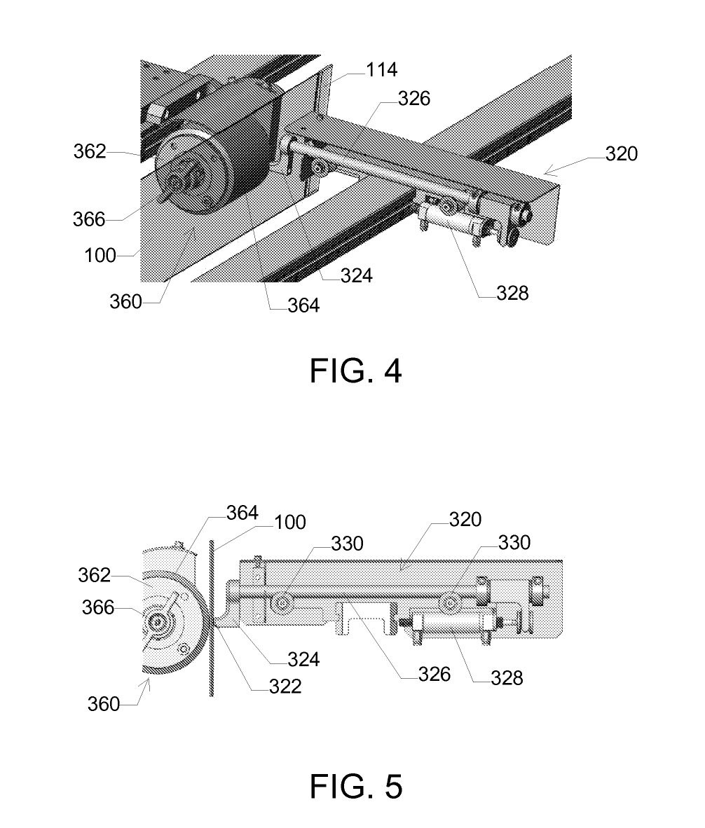

FIGS. 4-5 are perspective and side views, respectively, of one exemplary embodiment of scoring unit 300. Scoring unit 300 comprises a scoring member 320. In some embodiments, scoring unit 300 comprises a backing member 360 positioned opposite scoring member 320 (e.g., on an opposite side of glass sheet 100 from the scoring member). Glass sheet 100 is movable relative to scoring unit 300 to form a scored region of the glass sheet as described herein. In some embodiments, scoring unit 300 is mounted on a support structure (e.g., a rail or beam) as shown in FIGS. 4-5. Thus, scoring unit 300 can remain substantially longitudinally stationary as glass sheet 100 moves in the longitudinal direction. In other embodiments, the scoring unit is mounted on a movable structure (e.g., a robot or movable carriage). Thus, the glass sheet can remain substantially stationary as the scoring unit moves. Either or both of the glass sheet or the scoring unit can move to cause relative movement of the glass sheet relative to the scoring unit.

In some embodiments, scoring member 320 comprises an engaging member 322 that is engageable with glass sheet 100 (e.g., first surface 110) to form the scored region of the glass sheet as described herein. For example, in some embodiments, engaging member 322 comprises a score wheel. The score wheel can comprise a suitable material including, for example, carbide, diamond, or combinations thereof. Additionally, or alternatively, the score wheel can comprise a suitable configuration (e.g., serrated or non-serrated) and angle. In other embodiments, the engaging member can comprise another suitable configuration including, for example, a scribing tip, a cutting disk, a concentrated heat source, a concentrated cooling source, or combinations thereof. Engaging member 322 is mounted to a score head 324, which is mounted to an end of a score shaft 326 as shown in FIGS. 4-5. For example, the score wheel is rotatably mounted to score head 324 such that the score wheel is configured to rotate upon engagement with glass sheet 100. Additionally, or alternatively, score head 324 is rotatably mounted to score shaft 326. Thus, score head 324 is rotatable about score shaft 326 to enable engaging member 322 to move in the transverse direction. Such transverse movement of engaging member 322 can enable the engaging member to move with glass sheet 100 (e.g., in a side-to-side direction) to maintain spacing between the engaging member and the side edge of the glass sheet.

In some embodiments, the scoring member comprises a plurality of engaging members (e.g., a plurality of score wheels). For example, the score head comprises a rotatable carousel with the engaging members disposed about the carousel. The engaging members are sequentially movable in and out of an engaging position in response to rotation of the carousel. Thus, each engaging member can be moved in and out of service to enable service and/or replacement of the engaging member during operation of the system.

Score shaft 326 is movable in a direction perpendicular to a plane of glass sheet 100 to adjust an engaging force of scoring member 320 against the glass sheet. For example, score shaft 326 is movable toward glass sheet 100 to press engaging member 322 into the glass sheet and increase the engaging force and is movable away from the glass sheet to pull the engaging member away from the glass sheet and decrease the engaging force. In some embodiments, scoring member 320 comprises an actuating member 328 as shown in FIGS. 4-5 to adjust the engaging force. For example, actuating member 328 is coupled to an end of score shaft 326 opposite engaging member 322 to move the score shaft toward and/or away from glass sheet 100. Thus, actuating member 328 is operatively coupled to engaging member 322 via score shaft 326. Actuating member 328 can comprise a suitable actuator including, for example, a spring, a pneumatic or hydraulic cylinder (e.g., an air cylinder), a motor (e.g., an electric motor, a hydraulic motor, or a pneumatic motor), or combinations thereof. In some embodiments, an intermediate portion of score shaft 326 is engaged by one or more support rollers 330. Support rollers 330 can aid in reducing the frictional force acting on score shaft 326 during movement thereof, which can enable smooth movement of the score shaft for precise adjustment of the engaging force.

In some embodiments, backing member 360 comprises a backing roller that is engageable with glass sheet 100 (e.g., second surface 112) to aid in forming the scored region of the glass sheet as described herein. For example, backing member 360 comprises a roller member 362 comprising an outer surface 364 that is engageable with glass sheet 100 opposite score wheel 322 as shown in FIGS. 4-5. In some embodiments, outer surface 364 comprises a material with a durometer or hardness suitable for engaging glass sheet 100. For example, outer surface 364 comprises a material with a durometer of from about 50 to about 90, measured on the shore A scale. For example, in some embodiments, the material comprises a silicone material. Additionally, or alternatively, outer surface 364 comprises a material with a hardness of from about 30 to about 70, measured on the Rockwell C scale. Additionally, or alternatively, outer surface 364 comprises a material with a hardness of from about 2 to about 3, measured on the Mohs scale.

In some embodiments, roller member 362 comprises a core roller and an outer cover about core roller. The outer cover can comprise the material with the suitable durometer or hardness for engaging glass sheet 100. In some embodiments, backing member 360 comprises an axle 366. For example, roller member 362 is rotatably mounted to axle 366. Thus, roller member 362 is configured to roll along glass sheet 100 as the glass sheet moves relative to scoring unit 300 as described herein. Roller member 362 can roll freely (e.g., in response to movement of glass sheet 100). Alternatively, roller member 362 can be driven to rotate. For example, roller member 362 can be driven by a suitable driving unit including, for example, an electric motor, a hydraulic motor, a pneumatic motor, or combinations thereof. In other embodiments, the backing member can comprise another suitable configuration including, for example, a backing plate, a backing belt, or a backing disk. In various embodiments described herein, the backing member can support the glass sheet to enable the scoring member to be pressed into the glass sheet to form a score therein.

In some embodiments, backing member 360 is movable in a direction perpendicular to a plane of glass sheet 100 to aid in maintaining contact between outer surface 364 and glass sheet 100. For example, backing member 360 is movably (e.g., pivotally or slidably) mounted on a support structure (e.g., a rail or beam) as shown in FIGS. 4-5. Thus, backing member 360 comprises a floating mount and is configured to move relative to the support structure to move roller member 362 toward and/or away from glass sheet 100. In some embodiments, backing member 360 comprises a distance detecting unit to detect a distance between the backing member and glass sheet 100. The detected distance can be used to adjust the position of backing member 360 relative to the support structure and maintain contact between the backing member and glass sheet 100 as described herein. Additionally, or alternatively, backing member 360 is movable in a transverse direction substantially parallel to the plane of glass sheet 100. For example, backing member 360 is rotatably mounted to the support structure to enable backing member 360 to move in the transverse direction. Such transverse movement of backing member 360 can enable the backing member to move with glass sheet 100 (e.g., in a side-to-side direction) to maintain spacing between the backing member and the side edge of the glass sheet.

In some embodiments, scoring unit 300 comprises a first scoring unit 300a and a second scoring unit 300b as shown in FIG. 1. For example, first scoring unit 300a is positioned adjacent to first edge region 114, and second scoring unit 300b is positioned adjacent to second edge region 116. Each of first scoring unit 300a and second scoring unit 300b can be configured as described herein with reference to scoring unit 300. First scoring unit 300a can form a first scored region extending longitudinally along glass sheet 100 between first edge region 114 and central region 118. Additionally, or alternatively, second scoring unit 300b can form a second scored region extending longitudinally along glass sheet 100 between second edge region 116 and central region 118. The first and second scored regions can aid in removing the beads from a glass pane separated from the glass sheet as described herein.

In some embodiments, severing unit 400 is disposed longitudinally downstream of scoring unit 300 as shown in FIG. 1. Severing unit 400 is configured to sever glass sheet 100 in a transverse direction along a severing line as described herein. In some embodiments, the transverse direction is substantially perpendicular to the longitudinal direction as shown in FIG. 1. Severing unit 400 can comprise a suitable severing member such as, for example, a score wheel, a blade, a laser, a torch, a heating and/or cooling element, a support and/or breaking bar, a compression nosing, or combinations thereof. Severing unit 400 can sever glass sheet 100 using a suitable technique such as, for example, scoring, bending, thermally shocking, ablating, melting, fracturing, laser cutting, shearing, ultrasonic breaking, or combinations thereof.

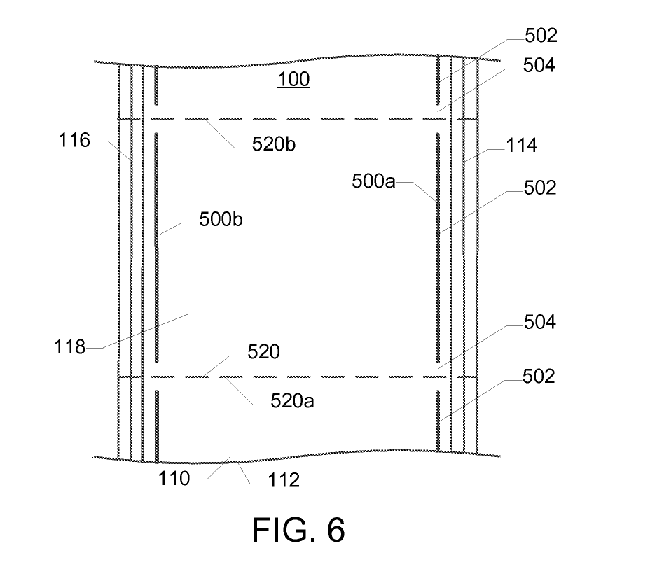

Scoring unit 300 can be used to score glass sheet 100 to form one or more scored regions of the glass sheet. FIG. 6 illustrates glass sheet 100 with a score 500 formed therein. For clarity, scoring unit 300 and severing unit 400 are omitted from FIG. 6. The scored region of glass sheet 100 comprises score 500 extending longitudinally along the glass sheet. For example, score 500 extends longitudinally along glass sheet 100 adjacent to first edge region 114 (e.g., between the first edge region and central region 118). Score 500 can enable removal of a bead from a glass pane separated from glass sheet 100 as described herein.

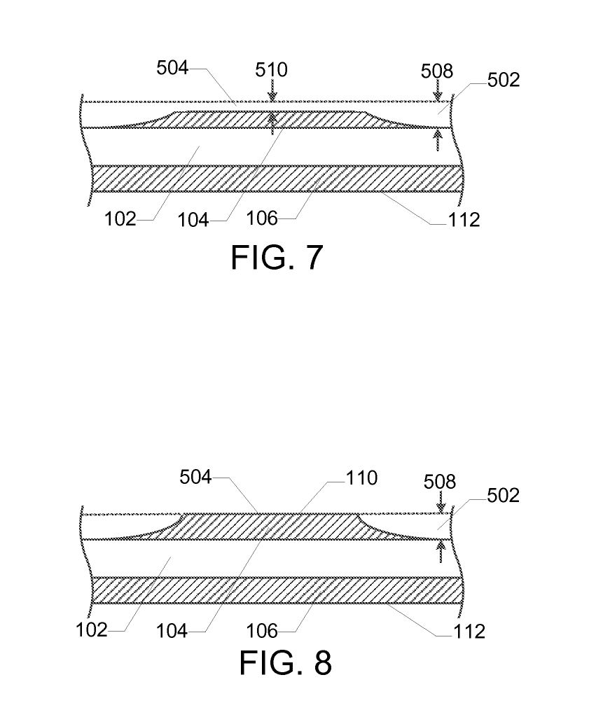

FIGS. 7-8 are cross-sectional views of a portion of glass sheet 100 with exemplary embodiments of score 500 formed therein taken along the scored region. Score 500 comprises a vent or a crack of certain depth formed in glass sheet 100. For example, score 500 comprises a groove or channel formed in first surface 110 of glass sheet 100. Score 500 extends into glass sheet 100 to a score depth. In some embodiments, the score depth is variable in the longitudinal direction. For example, score 500 comprises a dashed or broken score. Thus, the scored section of glass sheet 100 comprises at least one deep score portion 502 and at least one shoulder portion 504. In some embodiments, the scored region comprises a plurality of deep score portions 502 and a plurality of shoulder portions 504 as shown in FIG. 6. Shoulder portion 504 is disposed between adjacent deep score portions 502. In FIG. 7, the position of first surface 110 (e.g., prior to formation of score 500) is shown as a horizontal dashed line. Deep score portion 502 extends into glass sheet 100 to a deep score depth 508. In some embodiments, score 500 extends into glass sheet 100 at shoulder portion 504 to a shallow score depth 510 that is shallower than deep score depth 508 as shown in FIG. 7. Thus, deep score portion 502 is deeper than shoulder portion 504. In other embodiments, the shoulder portion comprises an unscored segment of the scored region disposed between adjacent deep score portions 502 as shown in FIG. 8. Thus, the shoulder portion is substantially free of a longitudinal channel or groove formed by scoring member 300. In other embodiments, the score extends into glass sheet 100 at the shoulder portion to a score depth that is deeper than deep score depth 508. Thus, the deep score portion is shallower than the shoulder portion.

The dashed score comprises alternating deep score portions 502 and shoulder portions 504 extending in the longitudinal direction along glass sheet 100 as shown in FIG. 6. Glass sheet 100 can be severed in the transverse direction between adjacent deep score portions 502 (i.e., at shoulder portion 504) to separate a pane from the glass sheet as described herein. The dashed score can enable glass sheet 100 to be severed without fracturing the glass sheet in an unintended location.

Each of deep score portion 502 and shoulder portion 504 comprises a length in the longitudinal direction. In some embodiments, deep score portion 502 is longer than shoulder portion 504. For example, a ratio of the length of deep score portion 502 to the length of shoulder portion 504 is at least about 20, at least about 50, or at least about 100. In some embodiments, shoulder portion 504 comprises a length of from about 2 mm to about 100 mm, from about 2 mm to about 50 mm, or from about 5 mm to about 10 mm. The length of shoulder portion 504 can be sufficiently large to enable glass sheet 100 to be severed in the transverse direction through the shoulder portion without fracturing the glass sheet at an unintended location. For example, if shoulder portion 504 is too short, severing glass sheet 100 through the shoulder portion can cause a fracture in the glass sheet to propagate in the longitudinal direction (e.g., toward one of the adjacent deep score portions 502), which can damage central region 118 of the glass sheet. Alternatively, if shoulder portion 504 is too long, a corner portion of central region 118 of the glass pane can be fractured during removal of the bead from the severed glass pane as described herein (e.g., because deep score portion 502 does not extend sufficiently close to the corner of the glass pane to enable a clean break in the longitudinal direction). In some embodiments, deep score portion 502 can extend along substantially the entire length of the glass pane. For example, in some embodiments, deep score portion 502 comprises a length of from about 3 m to about 5 m.

In some embodiments, the scored region of glass sheet 100 comprises a tapered portion disposed between deep score portion 502 and shoulder portion 504. For example, the score depth tapers between deep score depth 508 and shallow score depth 510 as shown in FIG. 7 or between the deep score depth and first surface 110 as shown in FIG. 8. In some embodiments, score 500 comprises a plurality of tapered portions each disposed between a deep score portion 502 and an adjacent shoulder portion 504. The tapered portion can be formed, for example, by varying the engaging force of scoring member 320 as described herein. Such gradual transitioning between deep score portion 502 and shoulder portion 504 can reduce the likelihood of damaging glass sheet 100 (e.g., by producing chips, crackouts, or other deformations in the glass sheet) during scoring of the glass sheet with scoring unit 300.

In some embodiments, score 500 is formed by engaging glass sheet 100 with scoring member 320 at a variable engaging force. For example, glass sheet 100 is moved in the longitudinal direction relative to scoring unit 300. Glass sheet 100 is engaged by scoring unit 300. For example, glass sheet 300 is passed between scoring member 320 and backing member 360 as shown in FIGS. 4-5. Backing member 360 engages second surface 112 of glass sheet 100. Scoring member 320 is pushed toward glass sheet 100 at a scoring force and engages first surface 110 of the glass sheet opposite backing member 360. Thus, glass sheet 100 is pinched between scoring member 320 and backing member 360. The force of engaging member 322 against first surface 110 of glass sheet 100 forms score 500 in the glass sheet. The longitudinal movement of glass sheet 100 relative to scoring unit 300 causes score 500 to be extended longitudinally along the glass sheet.

In some embodiments, a first longitudinal portion of glass sheet 100 is engaged with scoring member 320 at a first engaging force to form a first deep score portion. Subsequently, a second longitudinal portion of glass sheet 100 disposed upstream of the first longitudinal portion is engaged with scoring member 320 at a second engaging force that is less than the first engaging force to form the shoulder portion. Subsequently, a third longitudinal portion of glass sheet 100 disposed upstream of the second longitudinal portion is engaged with scoring member 320 at a third engaging force that is greater than the second engaging force to form a second deep score portion. Thus, scoring member 320 is pressed against glass sheet 100 at the first engaging force to form the first deep score portion, the engaging force is reduced to the second engaging force (e.g., to pull the scoring member away from the glass sheet) to form the shoulder portion, and the engaging force is increased to the third engaging force (e.g., to push the scoring member toward the glass sheet) to form the second deep score portion.

Scoring member 320 can engage glass sheet 100 at alternating high and low engaging forces during longitudinal movement of the glass sheet to form the dashed score. In some embodiments, scoring member 320 transitions gradually between the high and low engaging forces to form tapered portions of score 500 as described herein. Such a gradual transition can reduce the likelihood of damaging glass sheet 100 as described herein.

In some embodiments, glass sheet 100 comprises core layer 102 and a cladding layer (e.g., first cladding layer 104 and/or second cladding layer 106) adjacent to the core layer as described herein. In some of such embodiments, deep score depth 508 is greater than or equal to a thickness of the cladding layer as shown in FIGS. 7-8. Thus, deep score portion 502 of score 500 extends entirely through the cladding layer. Core layer 102 can be exposed at deep score portion 502, which can enable fracturing of glass sheet 100 along score 500 as described herein. Additionally, or alternatively, shallow score depth 510 is less than the thickness of the cladding layer as shown in FIG. 7. Core layer 102 can be unexposed (i.e., covered by the cladding layer) at shoulder portion 504, which can aid in preventing unintended fracturing or breakage of glass sheet 100 during severing of the glass sheet as described herein. In other embodiments, the deep score depth is less than the thickness of the cladding layer. Thus, the core layer remains unexposed at the deep score portion. Additionally, or alternatively, the shallow score depth is greater than or equal to the thickness of the cladding layer. Thus, the core layer is exposed at the shoulder portion.

In some embodiments, glass sheet 100 is contacted by scoring member 320 at a suitable viscosity for scoring the glass sheet. For example, a viscosity of a contacted region of glass sheet 100 in contact with scoring member 320 is at least about 1×10⁶ kP, at least about 1×10⁷ kP, at least about 1×10⁸ kP, at least about 2×10⁸ kP, at least about 1×10⁹ kP, at least about 5×10⁹ kP, at least about 1×10¹⁹ kP, at least about 2×10¹⁹ kP, at least about 1×10¹² kP, at least about 7×10¹² kP, at least about 1×10¹⁶ kP, at least about 2×10¹⁶ kP, or at least about 1×10¹⁸ kP. Additionally, or alternatively, the viscosity of the contacted region of glass sheet 100 in contact with scoring member 320 is at most about 1×10⁵⁰ kP, at most about 1×10⁴⁰ kP, at most about 1×10³⁰ kP, at most about 9×10²⁹ kP, at most about 1×10²⁸ kP, at most about 4×10²⁷ kP, at most about 1×10²¹ kP, at most about 7×10²⁰ kP, at most about 1×10¹⁵ kP, or at most about 2×10¹⁴ kP. Glass sheet 100 cools as it travels away from forming unit 200 in the longitudinal direction as described herein, and the viscosity of the glass sheet increases as the glass sheet cools. In some embodiments, scoring unit 300 is positioned a suitable distance downstream of forming unit 200 such that the region of glass sheet 100 engaged by scoring member 320 is within the desired viscosity range. Contacting glass sheet 100 with scoring member 320 while the glass sheet is in the desired viscosity range can enable scoring of the glass sheet without deforming and/or severing the glass sheet. In other words, glass sheet 100 can be sufficiently rigid at the longitudinal position of scoring member 320 that contacting the glass sheet with the scoring member causes formation of score 500 in the glass sheet as opposed to deforming and/or severing the glass sheet. Additionally, or alternatively, contacting glass sheet 100 with scoring member 320 while the glass sheet is within the desired viscosity range can enable scoring of the glass sheet before stresses, warp, and/or strengthening that can develop during cooling are able to develop sufficiently to become problematic for scoring the glass sheet. Thus, the contacted region of glass sheet 100 can be flatter, less stressed, and/or easier to mechanically score than it would be at a higher viscosity (e.g., after cooling to a lower temperature). As a result, relatively lower score force and/or less aggressive score wheels can be used to achieve sufficient score depth for subsequent bead separation. In some embodiments, glass sheet 100 comprises core layer 102 and a cladding layer (e.g., first cladding layer 104 and/or second cladding layer 106) adjacent to the core layer as described herein. The viscosity of the contacted region can comprise the viscosity of the cladding layer in contact with scoring member 320.

In some embodiments, a position of glass sheet 100 adjacent to backing member 360 is detected. For example, a distance between backing member 360 and glass sheet 100 is detected by a distance detecting unit. The distance detecting unit can comprise a suitable detecting unit including, for example, an ultrasonic detector, a laser detector, a vision system, a mechanical switch, a contact thermocouple, a contact touch probe, or combinations thereof. The position of backing member 360 relative to the support structure is adjusted in response to the detected position of glass sheet 100. Such adjustment of backing member 360 can enable contact between the backing member and glass sheet 100 to be maintained even if the glass sheet moves in the direction perpendicular to the plane thereof. For example, glass sheet 100 can move in forward and/or backward directions relative to a plane extending through draw line 230 of forming member 200 (e.g., a vertical plane). The position of backing member 360 can be adjusted so that the backing member moves in the forward and/or backward directions with glass sheet 100. Maintaining contact between backing member 360 and second surface 112 of glass sheet 100 can aid in providing uniform support to the glass sheet and/or maintaining a desired engaging force between scoring member 320 and first surface 110 of the glass sheet to control the score depth as described herein.

In some embodiments, scoring unit 300 can be movable in the longitudinal direction. For example, scoring unit 300 can be mounted on a track or movable carriage to enable the scoring unit to be longitudinally repositioned. The distance between forming unit 200 and scoring unit 300 can be adjusted (e.g., by repositioning the scoring unit) so that the contacted region of glass sheet 100 in contact with scoring member 320 is at the desired viscosity as described herein.

In some embodiments, glass sheet 100 is severed with severing unit 400. For example, glass sheet 100 is severed along a severing line 520 extending in a transverse direction through shoulder portion 504 of score 500 as shown in FIG. 6. Thus, scoring unit 300 and severing unit 400 are synchronized such that severing unit 400 engages glass sheet 100 downstream of scoring unit 300 at a longitudinal position of shoulder portion 504. In some embodiments, severing unit 400 is moved in the longitudinal direction with glass sheet 100 during the severing step. For example, severing unit 400 is mounted on a movable carriage (e.g., on a traveling anvil machine (TAM)). Thus, glass sheet 100 can move continuously in the longitudinal direction, and severing unit 400 can remain aligned with severing line 520 during the severing of the glass sheet. In some embodiments, severing unit 400 severs glass sheet 100 by drawing a score wheel across the glass sheet in the transverse direction along severing line 520. Additionally, or alternatively, severing unit 400 severs glass sheet 100 by heating the glass sheet along severing line 520 (e.g., with a laser, a torch, or a heating element). Additionally, or alternatively, severing unit 400 engages glass sheet 100 with one or more engaging bars to bend the glass sheet at severing line 520.

Severing glass sheet 100 along severing line 520 separates a glass pane from the glass sheet. In other words, the glass pane is cut from glass sheet 100 by severing the glass sheet along severing line 520. In some embodiments, the glass pane comprises an edge bead (e.g., at first edge region 114 and/or second edge region 116). The edge bead is removed from the glass pane by fracturing the glass pane at the scored region. For example, the glass pane is bent along score 500 to fracture the glass pane along the scored region. The position of score 500 between the edge bead and central region 118 of the glass pane can enable removal of the bead from the glass pane without damaging the central region.

In some embodiments, the scored region comprises a first scored region and a second scored region. Thus, score 500 comprises a first score 500a and a second score 500b as shown in FIG. 6 and described herein. For example, first score 500a is formed by first scoring unit 300a, and second score 500b is formed by second scoring unit 300b. First score 500a and/or second score 500b are configured as described herein with reference to score 500. For example, each of first score 500a and second score 500b comprises a dashed score comprising a deep score portion and a shoulder portion as described herein. In some embodiments, shoulder portions of first score 500a and shoulder portions of second score 500b are transversely aligned with one another. For example, a longitudinal position of a shoulder portion of first score 500a is substantially the same as a longitudinal position of a corresponding shoulder portion of second score 500b as shown in FIG. 6. In other embodiments, shoulder portions of the first score and shoulder portions of the second score are transversely misaligned with one another. For example, a longitudinal position of a shoulder portion of the first score is different than a longitudinal position of a corresponding shoulder portion of the second score. First score 500a is disposed between first edge region 114 and central region 118, and second score 500b is disposed between second edge region 116 and the central region. Severing line 520 can extend substantially the entire width of central region 118 between first score 500a and second score 500b. Additionally, or alternatively, severing line 520 can extend through the shoulder portion of each of first score 500a and second score 500b as shown in FIG. 6. Thus, glass sheet 100 can be severed along severing line 520 to separate the glass pane from the glass sheet without fracturing the glass sheet at an unintended location.

In some embodiments, the edge bead of the glass pane comprises a first edge bead (e.g., at first edge region 114) and a second edge bead (e.g., at second edge region 116). The first edge bead is removed from the glass pane by fracturing the glass pane at the first scored region. Additionally, or alternatively, the second edge bead is removed from the glass pane by fracturing the glass pane at the second scored region. For example, the glass pane is bent along first score 500a and/or second score 500b to fracture the glass pane along the respective scored region.

In some embodiments, severing line 520 comprises a first severing line 520a and a second severing line 520b positioned upstream of the first severing line as shown in FIG. 6. After severing glass sheet 100 along first severing line 520a, severing unit 400 is repositioned to align the severing unit with second severing line 520b. Second severing line 520b is aligned with shoulder portion 504 of score 500 (e.g., one of the plurality of shoulder portions positioned upstream of the shoulder portion with which first severing line 520a is aligned). The process described herein can be repeated to sever glass sheet 100 along second severing line 520b. Thus, a plurality of glass panes can be successively separated from glass sheet 100 in a continuous process.

In some embodiments, glass sheet 100 comprises a thickness of at least about 0.05 mm, at least about 0.1 mm, at least about 0.2 mm, or at least about 0.3 mm. Additionally, or alternatively, glass sheet 100 comprises a thickness of at most about 2 mm, at most about 1.5 mm, at most about 1 mm, at most about 0.7 mm, or at most about 0.5 mm. In some embodiments, a ratio of a thickness of core layer 102 to a thickness of glass sheet 100 is at least about 0.8, at least about 0.85, at least about 0.9, or at least about 0.95. In some embodiments, a thickness of the second layer (e.g., each of first cladding layer 104 and second cladding layer 106) is from about 0.01 mm to about 0.3 mm.

In some embodiments, glass sheet 100 is configured as a strengthened glass sheet. For example, in some embodiments, the second glass composition of the second layer (e.g., first and/or second cladding layers 104 and 106) comprises a different average coefficient of thermal expansion (CTE) than the first glass composition of the first layer (e.g., core layer 102). For example, first and second cladding layers 104 and 106 are formed from a glass composition having a lower average CTE than core layer 102. The CTE mismatch (i.e., the difference between the average CTE of first and second cladding layers 104 and 106 and the average CTE of core layer 102) results in formation of compressive stress in the cladding layers and tensile stress in the core layer upon cooling of glass sheet 100. In various embodiments, each of the first and second cladding layers, independently, can have a higher average CTE, a lower average CTE, or substantially the same average CTE as the core layer.

In some embodiments, the average CTE of the first layer (e.g., core layer 102) and the average CTE of the second layer (e.g., first and/or second cladding layers 104 and 106) differ by at least about 5×10⁻⁷° C.⁻¹, at least about 15×10⁻⁷° C.⁻¹, or at least about 25×10⁷° C.⁻¹. Additionally, or alternatively, the average CTE of the first layer and the average CTE of the second layer differ by at most about 40×10⁻⁷° C.⁻¹, at most about 30×10⁻⁷° C.⁻¹, at most about 20×10⁻⁷° C.⁻¹, or at most about 10×10⁻⁷° C.⁻¹. For example, in some embodiments, the average CTE of the first layer and the average CTE of the second layer differ by from about 5×10⁻⁷° C.⁻¹ to about 30×10⁻⁷° C.⁻¹ or from about 5×10⁷° C.⁻¹ to about 20×10⁻⁷° C.⁻¹. In some embodiments, the second glass composition of the second layer comprises an average CTE of at most about 40×10⁷° C.⁻¹ or at most about 35×10⁷° C.⁻¹ . Additionally, or alternatively, the second glass composition of the second layer comprises an average CTE of at least about 25×10⁷° C.⁻¹ or at least about 30×10⁻⁷° C.⁻¹. Additionally, or alternatively, the first glass composition of the first layer comprises an average CTE of at least about 40×10⁻⁷° C.⁻¹, at least about 50×10⁻⁷° C.⁻¹, or at least about 55×10⁻⁷° C.⁻¹. Additionally, or alternatively, the first glass composition of the first layer comprises an average CTE of at most about 80×10⁻⁷° C.⁻¹, at most about 70×10⁻⁷° C.⁻¹, or at most about 60×10⁻⁷° C.⁻¹.

In some embodiments, the compressive stress of the cladding layers is at least about 10 MPa, at least about 20 MPa, at least about 30 MPa, at least about 50 MPa, or at least about 100 MPa. Additionally, or alternatively, the compressive stress of the cladding layers is at most about 800 MPa, at most about 500 MPa, at most about 300 MPa, at most about 200 MPa, at most about 150 MPa, at most about 100 MPa, at most about 50 MPa, or at most about 40 MPa.

A strengthened laminated glass sheet as described herein can have increased stress along the edge beads compared to a single-layer glass sheet. For example, as a beaded glass sheet cools to room temperature after the forming process, the area along the beaded edges can become stressed and/or warped (e.g., as a result of uneven mass distribution and/or uneven cooling in this area compared to the central region of the glass sheet). The increased stress and warp can make scoring and separation problematic. Additionally, or alternatively, the glass sheet can become more scratch resistant and/or more breakage resistant during cooling. Thus, sheet shattering during scoring or upon separation can become common (e.g., as a result of high score forces, technically advanced score wheels, and/or mechanical breaking equipment). Scoring the glass sheet as described herein can enable a strengthened laminated glass sheet to be severed (e.g., at a shoulder portion of a dashed score) without unintended fracturing or breakage of the glass sheet.

The glass sheets described herein can be used for a variety of applications including, for example, for cover glass or glass backplane applications in consumer or commercial electronic devices including, for example, LCD and LED displays, computer monitors, and automated teller machines (ATMs); for touch screen or touch sensor applications; for portable electronic devices including, for example, mobile telephones, personal media players, and tablet computers; for integrated circuit applications including, for example, semiconductor wafers; for photovoltaic applications; for architectural glass applications; for automotive or vehicular glass applications; for commercial or household appliance applications; or for lighting applications including, for example, solid state lighting (e.g., luminaires for LED lamps).

It will be apparent to those skilled in the art that various modifications and variations can be made without departing from the spirit or scope of the invention. Accordingly, the invention is not to be restricted except in light of the attached claims and their equivalents.

What is claimed is:

1. A method comprising:
scoring a glass sheet to form a scored region of the glass sheet, the scored region extending in a longitudinal direction and comprising a plurality of deep score portions and a shoulder, portion disposed longitudinally between adjacent deep score portions; and
severing the glass sheet along a severing line extending in a transverse direction substantially perpendicular to the longitudinal direction and through the shoulder portion of the scored region.

2. The method of claim 1, wherein the scoring, the glass sheet comprises engaging the glass sheet with a scoring member and moving the glass sheet in the longitudinal direction relative to the scoring member.

3. The method of claim 2, wherein the engaging the glass sheet with the scoring member comprises engaging the glass sheet with the scoring member at a greater engaging force at the longitudinal positions of the deep score portions than at the longitudinal position of the shoulder portion.

4. The method of claim 2, wherein a viscosity of a contacted region of the glass sheet in contact with the scoring member is at least about 1×10⁶ kP and at most about 1×10⁵ kP.

5. The method of claim 2, wherein the scoring the glass sheet comprises passing the glass sheet between the scoring member and a backing member.

6. The method of claim 5, further comprising moving the backing member in a direction perpendicular to a plane of the glass sheet.

7. The method of claim 6, further comprising detecting a position of the glass sheet adjacent to the backing member, wherein the moving the backing member comprises moving the backing member in response to the detected position of the glass sheet to maintain the backing member in contact with a surface of the glass sheet.

8. The method of claim 2, wherein the plurality of deep score portions comprises a first deep score portion and a second deep score portion, and the engaging the glass sheet with the scoring member comprises:
engaging a first longitudinal portion of the glass sheet with the scoring member at a first engaging force to form the first deep score portion;
subsequently engaging a second longitudinal portion of the glass sheet with the scoring member at a second engaging force to form the shoulder portion; and
subsequently engaging a third longitudinal portion of the glass sheet with the scoring member at a third engaging force to form the second deep score portion;
wherein the second longitudinal portion of the glass sheet is positioned longitudinally between the first longitudinal portion and the second longitudinal portion, and the second engaging force is less than each of the first engaging force and the third engaging force.

9. The method of claim 1, wherein the shoulder portion of the scored region comprises a shallow score portion, and a depth of the shallow score portion is less than a depth of each of the deep score portions.

10. The method of claim 1, wherein the shoulder portion comprises an unscored segment of the scored region.

11. The method of claim 1, wherein the glass sheet is integrally connected to a molten glass source during the scoring the glass sheet.

12. The method of claim 1, wherein the severing the glass sheet comprises separating a glass pane from the glass sheet, and the method further comprises removing an edge bead of the glass pane by fracturing the glass pane along the scored region.

13. The method of claim 1, wherein:
the scored region comprises a first scored region and a second scored region, the first scored region is disposed between a first edge of the glass sheet and a central region of the glass sheet, and the second scored region is disposed between a second edge of the glass sheet and the central region of the glass sheet; and
the shoulder portion of the scored region comprises a first shoulder portion of the first scored region and a second shoulder portion of the second scored region, and the severing line extends in the transverse direction through each of the first shoulder portion and the second shoulder portion.

14-15. (canceled)

16. The method of claim 13, wherein the first shoulder portion of the first scored region and the second shoulder portion of the second scored region are transversely aligned with one another.

17. The method of claim 13, wherein the first shoulder portion of the first scored region and the second shoulder portion of the second scored region are transversely misaligned with one another.

18-23. (canceled)

24. A system comprising:
a scoring member engageable with a moving glass sheet at alternating high and low engaging forces to form a dashed score extending longitudinally along the glass sheet; and
a severing unit disposed longitudinally downstream of the scoring member and engageable with the glass sheet along a severing line extending in a transverse direction substantially perpendicular to the longitudinal direction along the glass sheet;
wherein the scoring member and the severing unit are synchronized such that the severing line is disposed at a longitudinal region of the glass sheet previously engaged by the scoring member at the low engaging force.

25. The system of claim 24, wherein the scoring member is engageable with a first surface of the glass sheet, and the system further comprises a backing member disposed opposite the scoring member and engageable with a second surface of the glass sheet.

26. The system of claim 25, wherein the scoring member comprises an engaging member, and the engaging member is movable in the transverse direction.

27. The system of claim 25, wherein the backing member comprises a floating mount such that the backing member is movable in a direction perpendicular to a plane of the glass ribbon.

28. (canceled)

29. The system of claim 24, further comprising an actuating member operatively coupled to the scoring member and configured to adjust an engaging force of the scoring member between the alternating high and low engaging forces.
